(19) United States
(12) Patent Application Publication
(10) Pub. No.: US 2014/0238090 A1
(43) Pub. Date: Aug. 28, 2014

(54) Padlock

(71) Applicant: Glyn Green, Cannock (GB)

(72) Inventor: Glyn Green, Cannock (GB)

(21) Appl. No.: 14/190,348

(22) Filed: Feb. 26, 2014

(30) Foreign Application Priority Data
Feb. 26, 2013 (GB) 1303349.3

(51) Int. Cl. E05B 67/00

(52) U.S. Cl. CPC E05B 67/00
USPC 70/31; 70/14

(57) ABSTRACT

A padlock is disclosed. The padlock includes a body and a cylinder mounted within the body, the cylinder being able to rotate about a first axis relative to the body. The padlock is movable between a locked condition in which the lock cylinder is prevented from rotating about said first axis, and an unlocked condition in which the lock cylinder is able to rotate about said first axis. The cylinder includes a first bore perpendicular to the first axis and having a first end and an open second end, and the body includes a second bore having a first open end and a second open end, the second bore extending between the open second end of the first bore and an external surface of said body. The first and second bores are substantially collinear. The lock also has a rebate disposed on the external surface of the body adjacent the open second end of the second bore that allows access to the second bore from outside of the lock.

The present invention relates to an improved padlock.

Padlocks are commonly used in order to secure property, and are typically locked and unlocked as required, by means of either a key and key slot, or a combination operated assembly.

Padlocks normally comprise a solid body having a first end of a U-shaped shackle retained within the body, and a second end releasably retained within the body. When the padlock is unlocked by means of a key or a combination for example, the second end of the U-shaped shackle is released from the body of the padlock and the U-shaped shackle is able to be rotated about its first end and then engaged with the object to be locked. The second end of the U-shaped shackle is then re-engaged with the body in order to lock the padlock once again.

Turning now specifically to the body of the padlock, whilst this can be made from, for example, solid brass, it is also known to have a padlock benefiting from a laminated body, comprising a plurality of layered plates clamped together by means of upper and lower rivets at opposite ends of the body.

Laminated padlocks possess a number of advantages over padlocks having a solid body, including reduced manufacturing costs on account of the lower cost of stamping out multiple parts and assembling them with rivets when compared to machining or casting a solid body, for example.

Despite being a commonly used type of padlock, laminated padlocks suffer from a number of disadvantages. By means of example, during the manufacturing process, in particular when the upper and lower rivets are subjected to extremely high pressures in order to clamp the layered plates together as discussed above, if the pressure applied is too high, then the inside of the body of the padlock can become compressed, with the result that it can become damaged, for example, resulting in the various moving parts inside the padlock becoming lodged in position.

However, on account of the expense associated with the various component parts of the padlock, the damaged padlock is often disassembled to remove any non-damaged component parts for re-use.

Preferred embodiments of the present invention seek to overcome or at least alleviate at least the above disadvantages of the prior art.

Moreover, the application of extremely high pressures to the rivets in order to clamp the layered plates together requires the use of a specialised closing tool, the pins of the padlock normally have to be added to the lock at the manufacturing site (which would typically have such a closing tool present); that is, away from the customer, thereby increasing lead times.

In accordance with the present invention, there is provided a lock comprising:
(i) a body;
(ii) a lock cylinder mounted within the body, wherein the lock cylinder is adapted to rotate about a first axis relative to the body,
   wherein said lock is movable between a locked condition in which the lock cylinder is prevented from rotating about said first axis, and an unlocked condition in which the lock cylinder is able to rotate about said first axis, wherein said lock cylinder comprises a first bore substantially perpendicular to said first axis and having a first end and an open second end, and said body comprises a second bore having a first open end and a second open end, said second bore extending between said open second end of said first bore and an external surface of said body, said second bore being substantially collinear with said first bore,

characterised in that said lock further comprises a rebate disposed on said external surface of said body and adjacent said open second end of said second bore to allow for access to said second bore from outside of said lock.

This provides the advantage that the lock can be completely assembled apart from the addition of the pins, which can be inserted into the bores of the lock as a final step in the manufacturing process when everything else has been assembled. This is advantageous in view of the fact that, in the case of a laminated padlock, it is normal practice to clamp the layered plates of the body together using rods and rivets, by means of applying extremely high pressure to the rivets at each end of the lock in order to compress the layered plates and retain them in position. This compression, if it is too high, can cause the lock itself to become compressed, with the result that the bores in which the pins move, are made smaller, with the result that the pins can become lodged; that is, no longer free to move within the bores. By facilitating the insertion of the pins into the otherwise completely assembled lock; that is, as a final step in the manufacturing process after the compression step; then in the unfortunate event that the bores are compressed, although the lock itself would need to be discarded, the pins would not be wasted, or would not need to be removed from the remainder of the lock (which itself takes time and therefore increases manufacturing costs) in the event that the pins need to be recycled.

This provides the further advantage that the pins could be inserted in the final stages of manufacture, closer to the customer, for example at a locksmith's premises. This is particularly advantageous when the customer has specific requirements for the pins; for example, when they wish to have a specific key design facilitate the opening and closing of the lock.

Preferably, said lock is a padlock.

Preferably, said lock further comprises a first pin having a first end and a second end, and a second pin adjacent said second end of said first pin, said first and second pins being movable between said first and second bores between a first condition in which the interface between the second end of the first pin and the second pin is not aligned with an interface between the lock cylinder and the body to substantially prevent the lock cylinder from rotating about said first axis, and a second condition in which the interface between the second end of the first pin and the second pin is aligned with said interface between the lock cylinder and the body, thereby allowing for rotation of the lock cylinder about said first axis.

Preferably, said rebate allows for selective removal and insertion of said first and second pins from said lock, and said lock further comprises a plug adapted to be disposed in said rebate in order to close said open second end of said second bore and retain said first and second pins in said lock.

This provides the advantage that the pins can be retained within the lock once they have been inserted into the lock in the final stages of manufacture, by means of insertion of the plug into the rebate. By inserting the plug into the rebate, the plug is substantially flush against the external surface of the body, thereby not drawing the attention of an unauthorised party to the plug and reducing the likelihood that an unauthorised party could remove the plug from the lock to gain access to the pins and thereby circumvent the lock.

Preferably, said lock cylinder further comprises a further first bore spaced apart from and substantially parallel with said first bore and having a first end and an open second end, and said body further comprises a further second bore having a first open end and an open second end, said further second bore extending between said open second end of said further first bore and said external surface of said body, said further second bore being substantially collinear with said further first bore, wherein said rebate is additionally disposed adjacent said open second end of said further second bore to additionally allow for access to said further second bore from outside of said lock.

Preferably, said rebate overlaps both said open second end of said second bore and said open second end of said further second bore.

This provides the advantage that, in the case where the lock is a laminated padlock, the rebate may be formed by means of manufacture of the layered plates such as to form said rebate when the layered plates are assembled together. To drill into the side of the padlock would not generally be possible when the lock is a laminated padlock and so the formation of a rebate in this way allows for insertion of the pins into the lock as a final stage in the manufacturing process; that is, after the compression stage.

Preferably said rebate is an elongate slot.

Preferably, said lock further comprises a further first pin having a first end and a second end, and a further second pin adjacent said second end of said further first pin, said further first pin and said further second pin being movable between said further first bore and said further second bore between a first condition in which the interface between the second end of the further first pin and the further second pin is not aligned with said interface between the lock cylinder and the body to substantially prevent the lock cylinder from rotating about said first axis, and a second condition in which the interface between the second end of the further first pin and the further second pin is aligned with said interface between the lock cylinder and the body, thereby allowing for rotation of the lock cylinder about said first axis.

Preferably, said rebate further allows for selective removal and insertion of said further first pin and said further second pin from said lock, and said plug, when disposed in said rebate, closes said open second end of said further second bore and retains said further first pin and said further second pin in said lock.

Preferably, said lock cylinder further comprises a key slot for receiving a key, wherein said key, when inserted in said key slot, moves said first pin and said second pin, and said further first pin and said further second pin, to said respective second conditions in order to move said lock from said locked condition to said unlocked condition.

Preferably, said plug comprises an elongate reinforcement member disposed substantially perpendicular to said first axis.

This provides the advantage that the plug does not weaken the lock; that is, an unauthorised party is substantially prevented from gaining access to the pins of the lock by means of destroying the plug.

Preferably, said body comprises a plurality of layered plates disposed adjacent each other and substantially perpendicular to said first axis.

Preferably, said layered plates are maintained in contact with each other by means of at least one pressurising means adapted to apply compressive forces at opposite ends of said body, said compressive forces being in a direction substantially parallel to said first axis.

Preferably, said at least one pressurising means comprises at least one rod disposed substantially parallel to said first axis, said at least one rod being disposed through each said layered plate and retained in position by means of first and second rivets disposed at each end of said rod.

A preferred embodiment of the present invention will now be described, by way of example only and not in any limitative sense, with reference to the accompanying drawings in which:

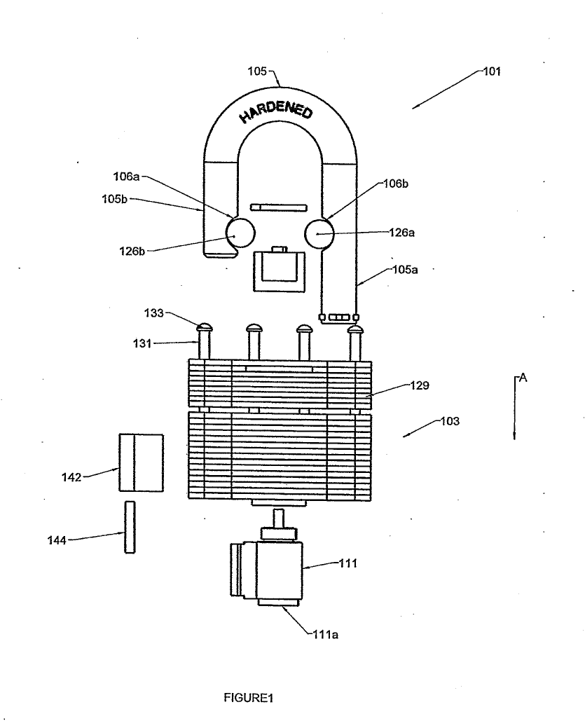

FIG. 1 shows an exploded view from the front of a lock in accordance with an embodiment of the present invention; and

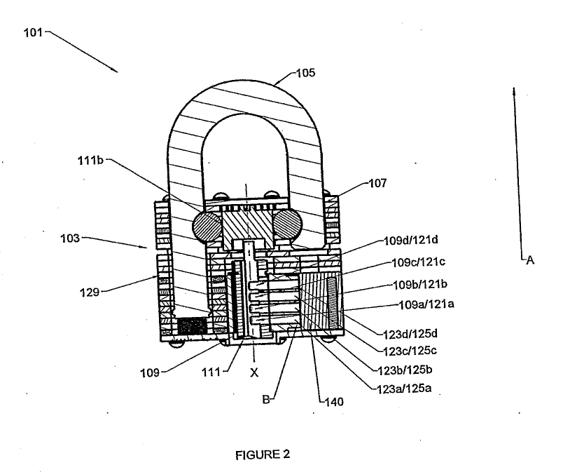

FIG. 2 shows a view from the front, showing hidden detail, of the lock of FIG. 1.

With reference to the Figures, a padlock is represented generally by reference numeral 101 comprising a body 103 having a U-shaped shackle 105 disposed therein. An arm 105a of the shackle 105 is movably retained within a first longitudinal cylindrical bore 107 in the body 103 and as a result, the shackle 105 is free to rotate through 360 degrees about longitudinal axis A, as well as being able to move, to a limited extent, in the direction indicated by the arrows; that is, parallel to a longitudinal axis A. The shackle 105 comprises a first rebate 106a disposed adjacent a second end 105b, and a second rebate 106b disposed opposite to the first rebate 106a, midway along the arm 105a of the shackle 105.

The padlock 101 further comprises a second longitudinal cylindrical bore 109. A lock cylinder 111 is housed inside the cylindrical bore 109. In order to open the lock, the lock cylinder 111 must rotate in the cylindrical bore 109, for the reasons explained below.

One end 111a of the lock cylinder 111 comprises a shaped aperture known as the key slot (not shown). A suitably shaped key (not shown) fits in the key slot. A second end 111b of the lock cylinder 111 comprises two rebates (not shown) oppositely disposed on its periphery.

A series of bores 119a to 119d, typically four in number and disposed substantially parallel to each other, are radially disposed into the lock cylinder 111 adjacent the key slot. These bores 119a to 119d each contain pins called differ pins 121a to 121d, which are of various lengths, and which are rounded at one end to permit a key to radially outwardly displace them when the key is inserted into the key slot.

Adjacent each differ pin 121a to 121d is a corresponding driver pin 123a to 123d, each of which are spring-loaded. The body 103 also has four radial bores 125a to 125d, which communicate and are collinear, with the bores 119a to 119d of the lock cylinder 111 and which house the spring-loaded driver pins 123a to 123d. Each bore 119 in the lock cylinder 111 communicates with a corresponding collinear bore 125 in the body 103, to form a continuous pathway between the bores 119 and 125.

When the correct key is not in the key slot, the pins 121a to 121d and 123a to 123d are pushed into the lock cylinder 111 by springs (not shown) and the driver pins 123a to 123d straddle the shear line X, thereby preventing the lock cylinder 111 from rotating, thereby maintaining ball bearings 126a and 126b in engagement with the first 106a and second 106b rebates respectively, preventing the second end 105b of the shackle 105 from disengaging from the body 103 and thereby keeping the padlock 101 in its locked condition.

With a properly shaped key inserted into the key slot of the lock cylinder 111, the pins 121a to 121d and 123a to 123d will move radially outwardly, and because the length of the pins is specially designed to match the shape of the key, the interface between each differ pin 121a to 121d and its corresponding driver pin 123a to 123d will exactly align with shear line X. This alignment allows the key and therefore the lock cylinder 111 with it, to rotate.

As a result of the rotation of the lock cylinder 111, ball bearings 125a and 125b align with the rebates in the second end 111b of the lock cylinder 111 respectively, with the result that the ball bearings 126a and 126b are able to retract from the first 106a and second 106b rebates respectively, on the shackle 105, as the shackle is urged in a direction away from the body 103; that is, as the second end 105b is urged out of engagement with the body 103. As a result, the shackle 105 is free to rotate, with the result that the padlock is in its unlocked condition.

Turning now specifically to the body 103 of the padlock, as can be seen from FIG. 1 in particular, it is laminated, which means that it is made from a plurality of layered plates 129, each one shaped so that when assembled in a layered arrangement, the requisite body 103 is formed. In order to maintain the layered plates 129 in position, rods 131 are located through each of the layered plates 129. The rods 131 are disposed substantially parallel to the longitudinal axis A, with upper rivets 133 and lower rivets (not shown) being used in order to maintain the layered plates 129 in close contact, thereby forming a sufficiently compact and robust padlock body 103. During the manufacturing process, the upper rivets 133 and lower rivets are subjected to extremely high pressures in order to compress the heads to ensure that the layered plates 129 do not move.

As can be seen from FIG. 2 in particular, each of the bores 125a to 125d in the body 103 are open ended; that is, they extend to an external surface B of the body 103, thereby allowing for access to the bores 119a to 119d and 125a to 125d from outside of the lock 101. The lock 101 further comprises a rebate 140 formed in the external surface B of the body, spanning the open ends of each of the bores 125a to 125d. The lock 101 further comprises a plug 142 which locates inside, and is retained within by means of a press fit, the rebate 140. The plug 142 forms a substantially continuous surface with the external surface of body 103 formed from the edges of layered plates 129. As a result of the continuous surface, there is nothing to gain any purchase on to grip the plug 142 in order to overcome the interference fit that retains the plug within the rebate 140.

The plug comprises a reinforcement member 144 disposed substantially parallel to the longitudinal axis A, which substantially prevents an unauthorised third party from circumventing the lock 101 by means of drilling out the plug 142.

The rebate 140 can be formed by means of pressing the various layered plates 129 with a requisite shape such that, when assembled, the rebate 140 is formed in the body 103.

The presence of the rebate 140 exposing the open ends of the bores 125a to 125d ensures that the pins 121a to 121d and 123a to 123d can be added once the rivets 133 and 135 have been added, thereby ensuring that the pins 121a to 121d and 123a to 123d are only added to a padlock 101 which has been correctly manufactured; that is, the correct pressure has been applied to the upper 133 and lower rivets in order to maintain the layered plates 129 securely in position without having damaged the lock 101.

Moreover, the ability to add the pins 121a to 121d and 123a to 123d once the upper 133 and lower rivets have been added enables the addition of the pins 121a to 121d and 123a to 123d to be a final stage in the manufacturing process, for example, at the locksmith's premises. In view of the fact that the rivets have already been added, the locksmith does not require the relatively expensive and sizeable closing tool typically used to add the rivets. Accordingly, the locksmith, who is generally closer to the customer, can ensure that the pin requirements of the customer are met (for example, facilitation of a master key), with a shorter lead time.

It will be appreciated by persons skilled in the art that the above embodiment has been described by way of example only, and not in any limitative sense, and that various alterations and modifications are possible without departing from the scope of the invention as defined by the appended claims.

1. A lock comprising:
(i) a body;
(ii) a lock cylinder mounted within the body, wherein the lock cylinder is adapted to rotate about a first axis relative to the body,
wherein said lock is movable between a locked condition in which the lock cylinder is prevented from rotating about said first axis, and an unlocked condition in which the lock cylinder is able to rotate about said first axis, wherein said lock cylinder comprises a first bore substantially perpendicular to said first axis and having a first end and an open second end, and said body comprises a second bore having a first open end and a second open end, said second bore extending between said open second end of said first bore and an external surface of said body, said second bore being substantially collinear with said first bore,
wherein said lock further comprises a rebate disposed on said external surface of said body and adjacent said open second end of said second bore to allow for access to said second bore from outside of said lock.

2. A lock as claimed in claim 1, wherein said lock is a padlock.

3. A lock as claimed in claim 1, further comprising a first pin having a first end and a second end, and a second pin adjacent said second end of said first pin, said first and second pins being movable between said first and second bores between a first condition in which the interface between the second end of the first pin and the second pin is not aligned with an interface between the lock cylinder and the body to substantially prevent the lock cylinder from rotating about said first axis, and a second condition in which the interface between the second end of the first pin and the second pin is aligned with said interface between the lock cylinder and the body, thereby allowing for rotation of the lock cylinder about said first axis.

4. A lock as claimed in claim 3, wherein said rebate allows for selective removal and insertion of said first and second pins from said lock, and said lock further comprises a plug adapted to be disposed in said rebate in order to close said open second end of said second bore and retain said first and second pins in said lock.

5. A lock as claimed in claim 1, wherein said lock cylinder further comprises a further first bore spaced apart from and substantially parallel with said first bore and having a first end and an open second end, and said body further comprises a further second bore having a first open end and an open second end, said further second bore extending between said open second end of said further first bore and said external surface of said body, said further second bore being substantially collinear with said further first bore, wherein said rebate is additionally disposed adjacent said open second end of said further second bore to additionally allow for access to said further second bore from outside of said lock.

6. A lock as claimed in claim 5, wherein said rebate overlaps with both said open second end of said second bore and said open second end of said further second bore.

7. A lock as claimed in claim 1, wherein said rebate is an elongate slot.

8. A lock as claimed in claim 5, further comprising a further first pin having a first end and a second end, and a further second pin adjacent said second end of said further first pin, said further first pin and said further second pin being movable between said further first bore and said further second bore between a first condition in which the interface between the second end of the further first pin and the further second pin is not aligned with said interface between the lock cylinder and the body to substantially prevent the lock cylinder from rotating about said first axis, and a second condition in which the interface between the second end of the further first pin and the further second pin is aligned with said interface between the lock cylinder and the body, thereby allowing for rotation of the lock cylinder about said first axis.

9. A lock as claimed in claim 8, wherein said rebate further allows for selective removal and insertion of said further first pin and said further second pin from said lock, and said plug, when disposed in said rebate, closes said open second end of said further second bore and retains said further first pin and said further second pin in said lock.

10. A lock as claimed in claim 8, wherein said lock cylinder further comprises a key slot for receiving a key, wherein said key, when inserted in said key slot, moves said first pin and said second pin, and said further first pin and said further second pin, to said respective second conditions in order to move said lock from said locked condition to said unlocked condition.

11. A lock as claimed in claim 4, wherein said plug comprises an elongate reinforcement member disposed substantially perpendicular to said first axis.

12. A lock as claimed in claim 1, wherein said body comprises a plurality of layered plates disposed adjacent each other and substantially perpendicular to said first axis.

13. A lock as claimed in claim 12, wherein said layered plates are maintained in contact with each other by of at least one pressurising device adapted to apply compressive forces at opposite ends of said body, said compressive forces being in a direction substantially parallel to said first axis.

14. A lock as claimed in claim 13, wherein said at least one pressurising device comprises at least one rod disposed substantially parallel to said first axis, said at least one rod being disposed through each said layered plate and retained in position by means of first and second rivets disposed at each end of said rod.
